(19) United States
(12) Patent Application Publication
(10) Pub. No.: US 2019/0024728 A1
(43) Pub. Date: Jan. 24, 2019

(54) ELECTROMECHANICAL ACTUATOR FOR ACTUATING A SYSTEM THAT TRANSMITS FORCE BY MEANS OF FRICTIONAL LOCKING

(71) Applicant: KNORR-BREMSE SYSTEME FUER NUTZFAHRZEUGE GMBH, Muenchen (DE)

(72) Inventors: Levente Balogh, Szigetszentmiklos (HU); Gabor Szucs, Kecskemet (HU); Balazs Trencseni, Budapest (HU)

(21) Appl. No.: 16/080,562

(22) PCT Filed: Feb. 23, 2017
(86) PCT No.: PCT/EP2017/054113

§ 371 Date: Aug. 28, 2018

(30) Foreign Application Priority Data
Mar. 4, 2016 (DE) 10 2016 002 645.6

(51) Int. Cl. F16D 13/75; F16D 28/00

(52) U.S. Cl. CPC F16D 13/752; F16D 2500/5114; F16D 28/00

(57) ABSTRACT

An electromechanical actuator for activating, by an actuating element, a system that transmits force by frictional locking, which actuating element at least partially produces or removes a normal force for the frictional locking, including: a housing; the actuating element, which is mounted in the housing for axial movement and is movable at least between a first axial position and a second axial position; an electronic control unit; an electromechanical rotary drive, which is controlled by the electronic control unit and which rotationally drives a shaft mounted in the housing; a wear compensation mechanism to compensate for wear of the force transmitting system, which is mounted axially movably in the housing; a transforming mechanism to transform the rotation of the shaft into an axial translation of the wear compensation mechanism, wherein the axial translation of the wear compensation mechanism acts on the actuating element, as described herein.

### FIELD OF THE INVENTION

The present invention relates to an electromechanical actuator for activating, by an actuating element, a system that transmits force by frictional locking, which actuating element at least partially produces or removes a normal force for the frictional locking, comprising a housing, an actuating element, which is mounted in the housing for axial movement and can be moved at least between a first axial position and a second axial position, an electronic control unit, an electromechanical rotary drive, which is controlled by the electronic control unit and rotationally drives a shaft mounted in the housing, a wear compensation mechanism designed to compensate for wear of the force transmitting system, which is mounted axially movably in the housing, a transforming mechanism, which transforms the rotation of the shaft into an axial translation of the wear compensation mechanism, wherein the axial translation of the wear compensation mechanism acts on the actuating element. The invention also relates to a system that transmits force by frictional locking, in which frictional forces between two frictional partners are generated in dependence on a normal force.

### BACKGROUND INFORMATION

An electromechanical actuator or such a system that transmits force by frictional locking is believed to be discussed, for example, with respect to FIG. 11 of heretofore unpublished European patent application number 15165585. There, it is left open how the wear compensation mechanism operates.

### SUMMARY OF THE INVENTION

The present invention therefore proposes to solve the problem of further developing an electromechanical actuator and a system of the kind described above so that its functions and especially the wear compensation for the system that transmits force by frictional locking can be designed in the most simple possible manner.

This problem is solved according to the invention by the features described herein.

According to the present invention, it is provided that
the wear compensation mechanism contains at least two mutually rotatable bodies, a first body and a second body, wherein a relative rotation of the bodies brings about an axial length change of the wear compensation mechanism, and wherein
the first body can be coupled in rotation with the shaft or decoupled in rotation from the shaft by a freewheel and the second body is led in the housing in an axially movable, but torque-proof manner, wherein
the second body actuates the actuating element axially, and wherein
the freewheel is designed so that a rotational coupling or rotational decoupling of the shaft in relation to the first body is dependent at least on the rotation direction of the shaft, and wherein
a sensor device detects the actual axial position of at least one body of the actuator moved in translation by rotation of the rotary drive in the first axial position of the actuating element and sends a corresponding actual position signal to the electronic control unit, and
in the electronic control unit an axial nominal position is stored for the at least one body of the actuator moved in translation by rotation of the rotary drive in the first axial position of the actuating element, wherein
   the electronic control unit controls the rotary drive for the moving of the actuating element from the first axial position to the second axial position such that the shaft turns in a first rotation direction and with a first rotational speed at which the freewheel decouples the first body in rotation from the shaft and the transforming mechanism transforms the rotation of the shaft into an axial translation of the wear compensation mechanism, corresponding to the movement of the actuating element from the first axial position to the second axial position, and
   the electronic control unit controls the rotary drive for the moving of the actuating element from the second axial position to the first axial position such that the shaft turns in the first rotation direction and with a second rotational speed, less than the first rotational speed, at which the Fcan freewheel decouples the first body in rotation from the shaft, and
   upon the control unit detecting a deviation beyond a permitted degree of the actual axial position of the at least one body of the actuator having moved in translation by the rotation of the rotary drive from the axial nominal position, the electronic control unit controls the rotary drive such that the shaft is actuated in a second rotation direction, opposite to the first rotation direction, in which the freewheel couples the first body to the shaft in rotation and the first body is turned relative to the second body, changing the axial length of the wear compensation mechanism, such that the deviation is compensated.

In other words, the rotary drive is actuated by the control unit both to move the actuating element from the first axial position to the second axial position and also to move the actuating element from the second axial position to the first axial position, such that the shaft always rotates in the first rotation direction and the movement direction, i.e., a movement of the actuating element from the first axial position to the second axial position or from the second axial position to the first axial position depends only on the rotational speed of the shaft.

The centrifugally controlled transforming mechanism may be centrifugally controlled and designed so that it transforms the rotation of the shaft into an axial translation of the wear compensation mechanism depending on the rotational speed of the shaft, an increasing rotational speed of the shaft producing larger centrifugal forces and hence a greater translation and vice versa, a decreasing rotational speed of the shaft producing smaller centrifugal forces and hence a lesser translation.

Therefore, if the electronic control controls the rotary drive in order to move the actuating element from the second axial position to the first axial position such that the shaft is turning in the first rotation direction and with a second, lower rotational speed as compared to the first rotational speed, then smaller centrifugal forces will be acting, resulting in smaller translation forces in the direction of the second axial position. Then, if the actuator activates for example a friction clutch device or a wheel brake device, the forces acting from these devices on the actuating element of the actuator and being oppositely directed, for example being generated by a clutch spring, are then able to restore the actuating element of the actuator against these lesser translation forces to the first axial position, which then corresponds to an engaged state of the friction clutch device or a released state of the wheel friction braking device.

But if the electronic control unit controls the rotary drive for the moving of the actuating element from the first axial position to the second axial position such that the shaft turns in the first rotation direction and with the first rotational speed, greater than the second rotational speed, greater centrifugal forces will then be acting, resulting in greater translation forces in the direction of the second axial position. Then, if the actuator activates for example a friction clutch device, the spring forces of this device are no longer able to restore the actuating element of the actuator against the then greater translation forces to the first axial position, which corresponds to the engaged state of the friction clutch device. Instead, the then larger translation forces acting against the spring force of the friction clutch device then provide a translation of the actuating element into the second axial position, which then corresponds to the disengaged state of the friction clutch device. The same holds for a wheel brake friction device.

Hence, for unchanged first rotation direction of the shaft, the movement direction of the actuating element (from the first axial position to the second axial position or from the second axial position to the first axial position) is controlled only by the rotational speed of the shaft, which can be easily accomplished by the control unit. The benefit is that no reversal of rotation direction of the rotary drive with moments of inertia involved is needed in order to manage both movement directions, so that the reversal of the movement direction offers high dynamics.

In order to adjust for an excessive wear of the system that transmits force by frictional locking by the actuator, the sensor device detects the actual axial position of at least one body of the actuator moved in translation by rotation of the rotary drive when the actuating element adopts or has adopted the first axial position and sends a corresponding actual position signal to the electronic control unit. Consequently, the actual axial position of the at least one body corresponds with the first axial position of the actuating element. Likewise, the memorized axial nominal position for the at least one body of the actuator moved in translation by rotation of the rotary drive also corresponds with the first axial position of the actuating element.

Then, if necessary, i.e., to adjust for a detected excessive wear upon the control unit detecting a deviation beyond a permitted degree of the actual axial position of the at least one body of the actuator having moved in translation by the rotation of the rotary drive from the axial nominal position, the rotary drive drives the shaft in the second rotation direction, this second rotation direction may be reserved exclusively for the adjustment for wear. Since an adjustment for wear is not required as often and as quickly as a reversal of the movement direction, the worse dynamics here are hardly a disadvantage.

Thanks to the measures described in the dependent claims, advantageous modifications and improvements are possible for the invention indicated in the independent claims.

According to one embodiment, the centrifugally controlled transforming mechanism contains at least the following:
at least one centrifugal mass which is rotary driven by the shaft, able to extend or retract in the radial direction, whose radial extending movement or retracting movement is dependent on the rotational speed of the shaft, wherein the extending movement becomes greater with increasing rotational speed and lesser with decreasing rotational speed,
a transmission which is rotationally coupled to the shaft, transforming the radial extending movement or retracting movement of the at least one centrifugal mass into an axial movement of a pressure piece co-rotating with the shaft, but axially movable with respect to the shaft.

Such a transforming mechanism is described for example in the above mentioned unpublished European patent application with the application number 15165585. Contrary to the transforming mechanism described there, the pressure piece can, by the freewheel, in a manner dependent on the rotation direction thereof, be rotationally coupled to the first body of the wear compensation mechanism or rotationally decoupled from the first body of the wear compensation mechanism.

According to one modification, the pressure piece is axially braced against the shaft by a compression spring device. The pressure piece is formed in particular by a sleeve, in whose sleeve bore the compression spring device is axially braced. Furthermore, the pressure piece has an extension which protrudes into the first body, wherein the freewheel in the shape of a ring for example is arranged between a radially inner circumferential surface of the first body and a radially outer circumferential surface of the extension of the pressure piece.

Especially, the transmission which is rotationally coupled to the at least one centrifugal mass may be a lever transmission. According to one modification, the lever transmission comprises at least one first lever, which is mounted to co-rotate with the shaft and is able to pivot on the shaft, directly or indirectly, about an axis which is perpendicular in relation to the axial direction and which carries at one end at least one centrifugal mass and which axially activates the pressure piece directly or indirectly by its other end.

According to one modification, the first body of the wear compensation mechanism is designed to be screwed by a thread with respect to the second body of the wear compensation mechanism. Alternatively, any mechanism is conceivable with which a transformation of a rotation movement of the first body into a translation movement of the second body is possible.

In order to save on components, the actuating element can be formed directly by the second body of the wear compensation mechanism.

The rotary drive may be formed by an electric motor, which is then easily controlled or regulated in its rotational speed by the control unit and can also be easily controlled in regard to the rotation direction.

The body of the actuator which is moved in translation by rotation of the shaft may be formed by a body of the wear compensation mechanism, the actuating element or by the pressure piece.

The invention also relates to a system transmitting force by frictional locking, especially in a vehicle, in which frictional forces between two frictional partners are generated in dependence on a normal force, the normal force being produced or at least partly removed by an actuator as specified above. It is conceivable to use the actuator in any system transmitting force by frictional locking where frictional forces between two frictional partners are generated in dependence on a normal force.

Especially, the system transmitting force by frictional locking may be formed by a friction clutch device of a drive machine of a vehicle or a wheel friction braking device of a vehicle. For in such systems, the frictional force between two frictional partners, in the case of the friction clutch device between two clutch disks and in the case of a wheel friction braking device between brake linings and a brake disk, is generated by a normal force, which is then at least partly produced or removed by the actuating element of the actuator, according to whether the two frictional partners are stressed against each other in the initial state or not.

By a wheel friction braking device may be meant a friction braking device which acts solely on a wheel or on several wheels arranged on an axle on the same side of the axle.

In a friction clutch device of a drive machine of a vehicle, the first axial position of the actuating element of the actuator corresponds for example to an engaged position, in which the friction clutch device is closed or engaged, while the second axial position of the actuating element represents for example a disengaged position in which the friction clutch device is opened or disengaged. In such a friction clutch device, an axial force acts from the friction clutch on the actuating element of the actuator, which forces it into the first axial position. This axial force is then overcome by the activating force generated on the actuating element by rotation of the shaft and directed oppositely during the movement from the first axial position to the second axial position.

The first axial position of the actuating element of the actuator in a wheel friction braking device of a vehicle corresponds to a released position of the wheel friction braking device, in which the wheel friction braking device is released, while the second axial position of the actuating element represents an applied position, in which the wheel friction braking device is applied.

In the following, a sample embodiment of the invention is represented in the drawing and explained more closely in the following description.

### BRIEF DESCRIPTION OF THE DRAWINGS

FIG. 1 shows a cross-sectional representation through an exemplary embodiment of an electromechanical actuator according to the invention.

FIG. 2a shows a cross-sectional representation of the electromechanical actuator of FIG. 1 during an actuating movement of an actuating element from a first axial position to a second axial position.

FIG. 2b shows a cross-sectional representation of a centrifugal mass of the electromechanical actuator during the actuating movement of the actuating element shown in FIG. 2a.

FIG. 3a shows a cross-sectional representation of the electromechanical actuator of FIG. 1 during an actuating movement of the actuating element from the second axial position to the first axial position.

FIG. 3b shows a cross-sectional representation of the centrifugal mass of the electromechanical actuator during the actuating movement of the actuating element shown in FIG. 3a.

FIG. 4a shows a cross-sectional representation of the electromechanical actuator of FIG. 1 during an adjusting movement of the actuating element for wear compensation.

FIG. 4b shows a cross-sectional representation of the centrifugal mass of the electromechanical actuator during the actuating movement of the actuating element shown in FIG. 4a.

### DETAILED DESCRIPTION

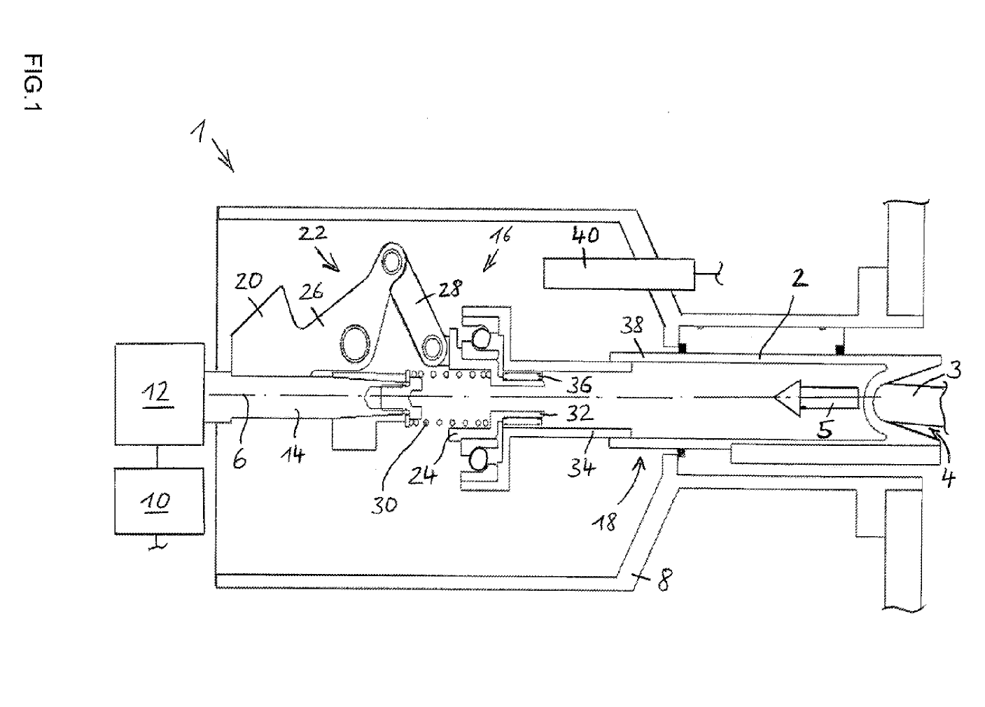

FIG. 1 shows an exemplary embodiment of an electromechanical actuator 1 according to the invention in cross section, wherein the actuator 1 activates for example a friction clutch device not shown here for a drive machine of a vehicle via an actuating element 2 of the actuator 1.

A first axial position of the actuating element 2 of the actuator 1 corresponds for example to an engaged position, in which the friction clutch device is closed or engaged, while the second axial position of the actuating element 2 represents for example a disengaged position, in which the friction clutch device is opened or disengaged. The actuating element 2 has a seat 4, here for example in the form of a recess, in which an activating element 3 of the friction clutch device engages, so that a movement of the actuating element 2 in the axial direction, which here runs parallel to or coaxially with a longitudinal axis 6 of the actuator, activates the coaxially activating element 3 of the friction clutch device. “Axial” thus always means here parallel to or coaxial with the longitudinal axis 6 of the actuator 1.

In the figures, a movement of the actuating element 2 to the right brings about a movement in the direction of the disengaged position (second axial position of the actuating element 2) and a movement of the actuating element 2 to the left brings about a movement in the direction of the engaged position (first axial position of the actuating element 2) of the friction clutch device. Since the activating element 3 of the friction clutch device is loaded by a clutch spring in the direction of the engaged position of the friction clutch device, i.e., to the left in FIG. 1, the spring force F_{K} symbolized by an arrow 5 in FIG. 1 acts as a restoring force across the activating element 3 also on the actuating element 2 in the direction of the engaged position (first axial position of the actuating element 2), to the left in the figures.

The actuating element 2 is mounted in a housing 8 of the actuator 1 in a torque-proof and axially movable manner and can be moved between the first axial position, corresponding to the engaged state of the friction clutch device, and the second axial position, corresponding to the disengaged state of the friction clutch device, wherein naturally intermediate positions between the first axial position and the second axial position can be taken up.

The actuator 1 furthermore contains an electromechanical rotary drive 12, controlled by an electronic control unit 10, for example in the form of an electric motor, which drives a shaft 14 mounted in a housing 8 of the actuator 1. On this shaft 14 is secured a co-rotating transforming mechanism 16, which transforms the rotation of the shaft 14 into an axial translation of a wear compensation mechanism 18 depending on the rotational speed of the shaft 14. The wear compensation mechanism 18 serves for compensating for wear on the friction clutch device and is mounted in an axially movable manner in the housing 8, for example via the actuating element 2.

The transforming mechanism 16 may be centrifugally controlled here and contains here for example several centrifugal masses 20 which can extend or retract in the radial direction, being rotary driven by the shaft 14, and their radial extending movement or retracting movement is dependent on the rotational speed of the shaft 14, wherein owing to centrifugal force, the extending movement becomes greater with increasing rotational speed and lesser with decreasing rotational speed. Furthermore, the transforming mechanism 16 contains a transmission 22 which is rotationally coupled to the centrifugal masses 20, transforming the radial extending movement or retracting movement of the centrifugal masses 20 into an axial movement of a pressure piece 24, co-rotating with the shaft 14, but axially movable with respect to the shaft 14. Especially, the transmission 22 which is rotationally coupled to the centrifugal masses 20 may be a lever transmission. The lever transmission 22 has here, for example, several first levers 26, which are mounted co-rotating with the shaft 14 and able to swivel on the shaft 14 directly or indirectly about axes perpendicular to the longitudinal axis 6, said first levers carrying at one end the centrifugal masses 20 and axially activating the pressure piece 24 by their other ends, for example, via second levers 28 hinged to the first levers 26. Such a transforming mechanism 16 is described for example in the above mentioned unpublished European patent application with the application number 15165585, whose disclosure in this regard is incorporated expressly in the present specification. Therefore, it shall not be further discussed here.

The pressure piece 24 which is rotationally coupled to the shaft 14 by the lever transmission 22 is axially braced against the shaft 14 by a compression spring device 30. The pressure piece 24 is formed in particular by a sleeve, in whose sleeve bore the compression spring device 30 is axially braced. Furthermore, the pressure piece 24 has an extension 32 which protrudes into a first body 34 of the wear compensation mechanism 18, wherein a freewheel 36 in the shape of a ring for example is arranged between a radially inner circumferential surface of the first body 34 and a radially outer circumferential surface of the extension 32 of the pressure piece 24.

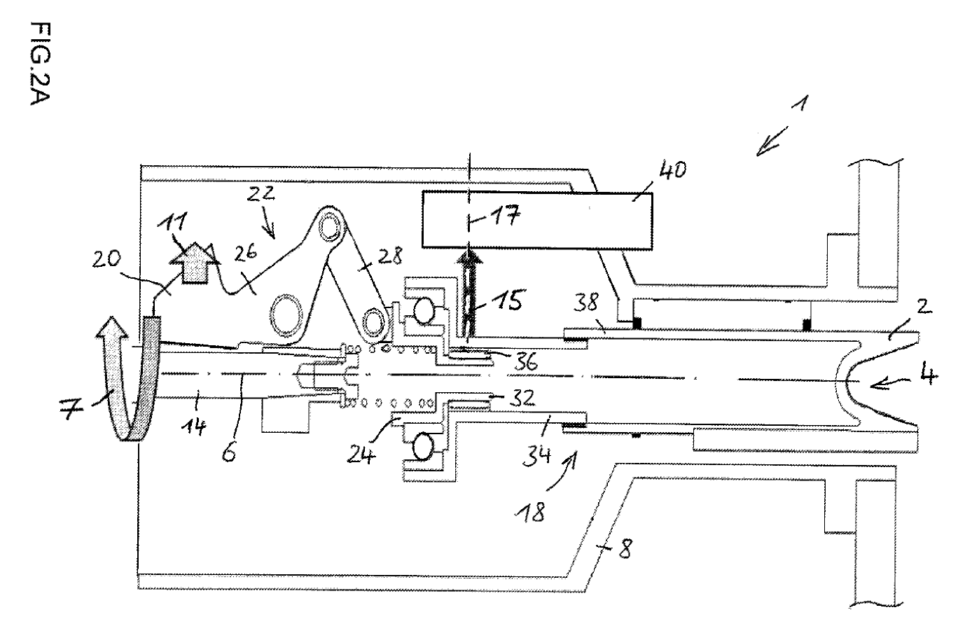

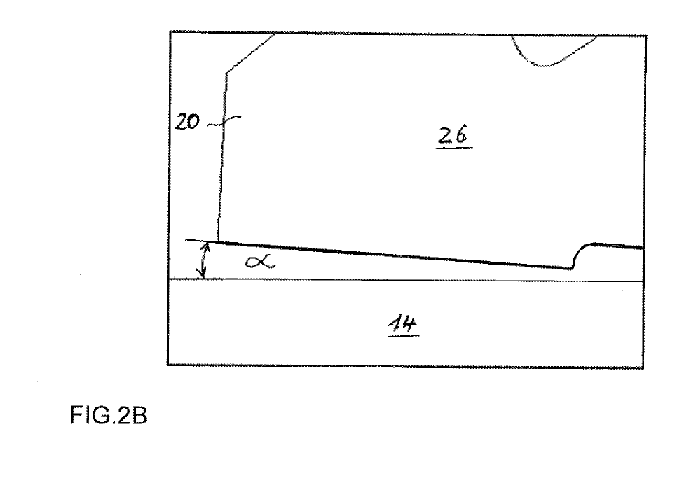

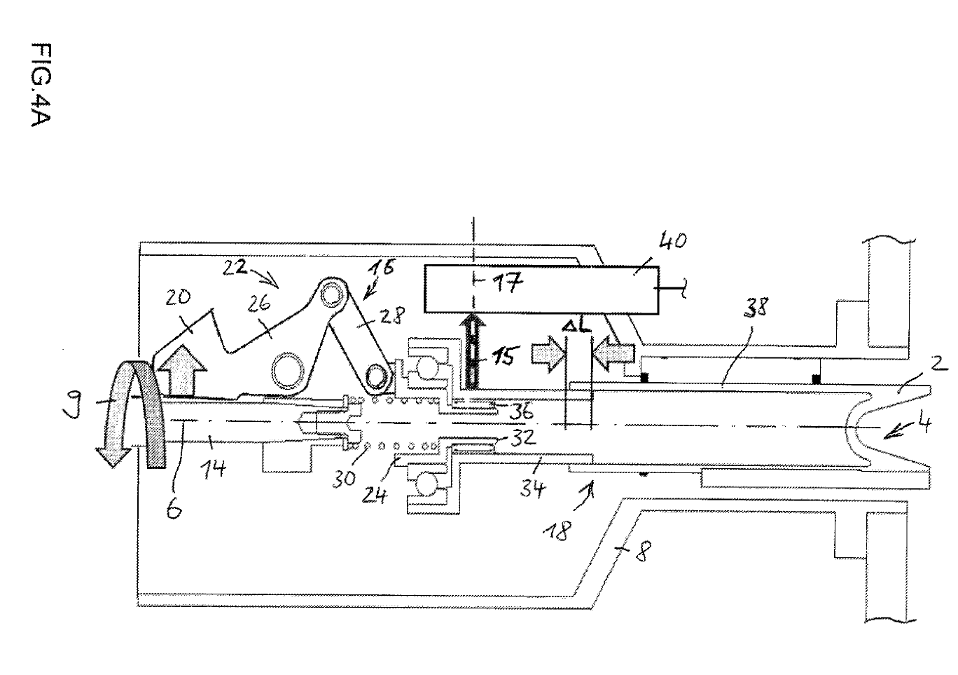

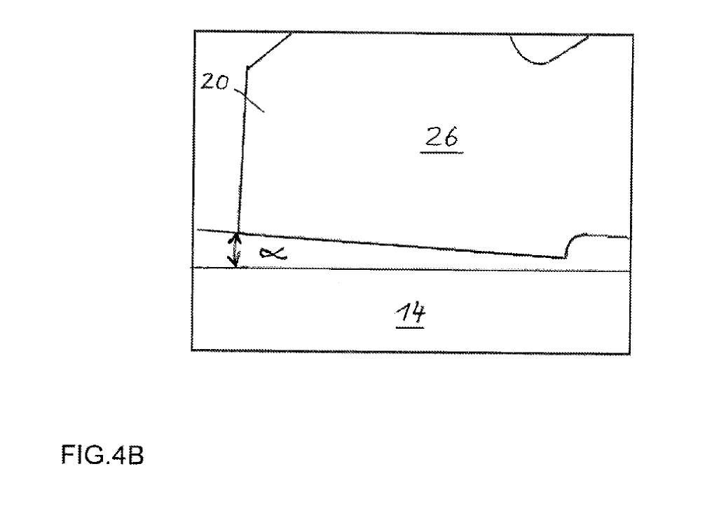

The freewheel 36 is designed such that a rotational coupling or rotational decoupling of the pressure piece 24 in relation to the first body 34 is dependent on the rotation direction of the shaft 14, for example, such that when the shaft 14 is turning in a first rotation direction, indicated in FIG. 2A by the curved arrow 7, for example, the freewheel 36 decouples the first body 34 from the shaft 14 in rotation. On the other hand, the freewheel 36 couples the first body 34 to the shaft 14 when the shaft is turning in a second rotation direction, opposite the first rotation direction, as illustrated by the curved arrow 9 in FIG. 4A.

The pressure piece 24 upon rotation of the shaft 14 in the first rotation direction is co-rotated with it and as a result of the centrifugal forces of the centrifugal masses 20 transmitted via the lever transmission 22 it is moved in translation at the same time in the direction of the second axial position. Consequently, the pressure piece 24 transmits axial and radial forces to the first body 34. For this, the extension of the pressure piece is mounted axially and radially in or on the first body, for example, by an angular contact ball bearing, so that both axial and radial forces can be transmitted between the pressure piece. In this way, the pressure piece 24 is mounted in the first body 34 axially firmly and fixed in rotation or able to rotate depending on the rotation direction of the shaft 14.

The first body 34 of the wear compensation mechanism 18 is configured as a sleeve, for example, and can turn by a thread in a second body 38 of the wear compensation mechanism 18, which may be configured as a sleeve. The second body 38 is guided lengthwise movable in the housing 8, but firm in rotation. Consequently, a rotation of the first body 34 with respect to the second body 38 always brings about a change in length of the wear compensation mechanism 18 in the axial direction, i.e., parallel or coaxial to the longitudinal axis 6.

The second body 38 of the wear compensation mechanism 18 may form the actuating element 2 here, which acts on the activating element of the friction clutch device. Consequently, the clutch wear on the friction clutch device can be compensated by a length change of the wear compensation mechanism 18 by rotation of the first body 34 with respect to the second body 38.

Furthermore, the actuator 1 contains a sensor device 40, such as a sensor device measuring by the induction principle, which detects the actual axial position 15 of the first body 34 of the wear compensation mechanism 18, for example, when the actuating element 2 has taken up or is taking up its first axial position, here, the engaged position of the friction clutch device. The sensor device 40 then sends a corresponding actual position signal to the electronic control unit 10. Furthermore, an axial nominal position 17 for the first body 34 in relation to the first axial position of the actuating element 2 is stored in the electronic control unit 10.

Alternatively to this, the actual axial position 15 of any given body of the actuator 1 can be detected by the sensor device 40 and compared to a corresponding axial nominal position 17, which undergoes a translation on account of the rotation of the electric motor 12, such as the actuating element 2, the second body 38 or the pressure piece 24.

Given this background, the functioning of the actuator 1 is as follows.

Per FIG. 2A, in which the state of the actuator 1 is shown in which the friction clutch device is not worn down, the electronic control unit 10 controls the electric motor 12 to move the actuating element 2 from the first axial position to the second axial position, i.e., from the engaged state to the disengaged state, such that the shaft 14 turns in the first rotation direction 7 and with the first rotational speed, at which the freewheel 36 decouples the first body 34 in rotation from the shaft 14 and the transforming mechanism 16 transforms the rotation of the shaft 14 into an axial translation of the wear compensation mechanism 18, corresponding to the moving of the actuating element 2 from the first axial position to the second axial position. The first body 34 then cannot be rotated, on account of the free-running freewheel 36, with respect to the second body 38, which is led in a torque-proof but lengthwise movable manner in the housing 8, so that the length of the wear compensation mechanism 18 is not changed and this is axially displaced in its unchanged length by the pressure piece 24.

The first relatively large rotational speed is indicated by the thick curved arrow 7 in FIG. 2A. Larger centrifugal forces illustrated by the arrow 11 are then acting on the centrifugal masses 20 of the transforming mechanism 16, resulting in larger translation forces in the direction of the second axial position. If, as in this case, the actuator 1 activates a friction clutch device, then the spring forces of this device are no longer able to reset the actuating element 2 of the actuator 1 against the then larger translation forces to the first axial position, which then corresponds to the engaged state of the friction clutch device. Instead, the larger translation forces acting against the spring force of the friction clutch device then ensure a translation of the actuating element 2 to the second axial position, corresponding then to the disengaged state of the friction clutch device.

In FIG. 2B the angle α between the centrifugal masses 20 and the shaft 14 is represented, such as results in the first axial position of the actuating element 2 at the start of the disengaging process. The sensor device 40 then detects the actual position of the first body 34 corresponding to the first axial position of the actuating element 2 at the start of the disengaging process and it sends a corresponding signal to the electronic control unit 10.

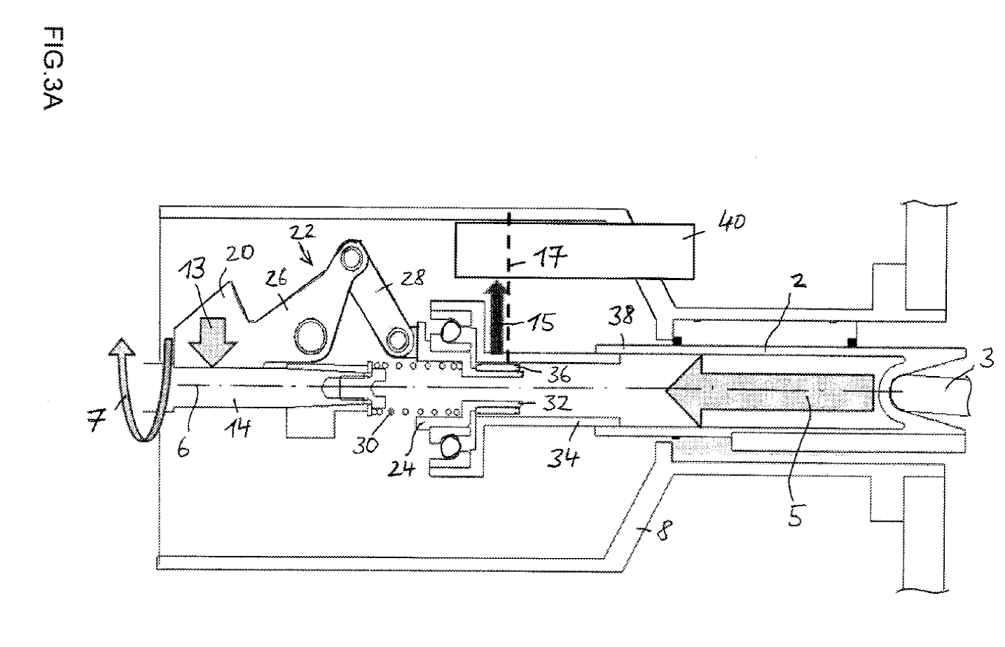

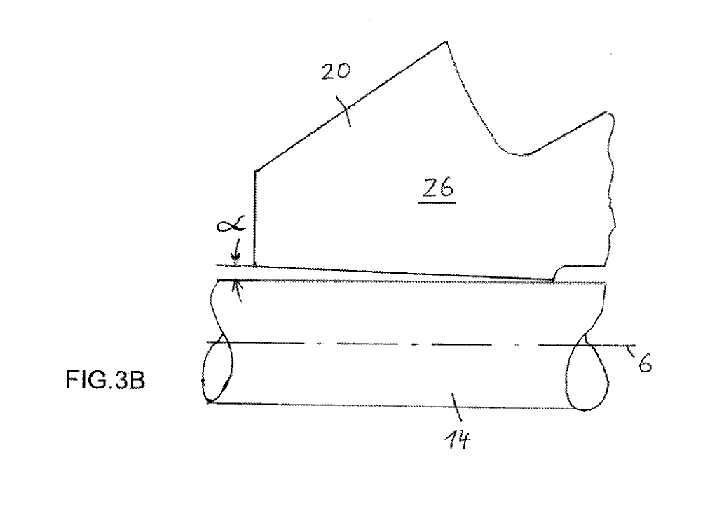

FIGS. 3A and 3B show the situation when the actuating element 2 is reset from the second axial position to the first axial position, i.e., from the disengaged state to the engaged state. While the shaft 14 continues to turn in the first rotation direction, it is with a second rotational speed, less than the first rotational speed, which is illustrated in FIG. 3A by a thinner arrow 7. In the first rotation direction, the freewheel 36 continues to maintain the first body 34 in rotational decoupling from the shaft 14, but on account of the lower second rotational speed the transforming mechanism 16 can only still transform the rotation of the shaft 14 into a then substantially smaller axial translation or translation force of the wear compensation mechanism 18. But the oppositely directed restoring force 5 of the clutch spring, which is transmitted across the activating element 3 and the actuating element 2 axially to the wear compensation mechanism 18, hinders this slight axial translation of the wear compensation mechanism 18. Instead, the restoring force 5 of the friction clutch device is greater, so that the actuating element 2 is returned from the second axial position to the first axial position, corresponding to the engaged state. The centrifugal masses 20 then migrate in the direction of the shaft, as illustrated by the arrow 13 in FIG. 3A.

The first body 34 once again cannot be rotated with respect to the second body 38, which is led in a torque-proof but lengthwise movable manner in the housing 8, on account of the still free-running freewheel 36, so that the axial length of the wear compensation mechanism 18 is not changed and this is displaced by the pressure piece 24 with unchanged axial length.

If the friction clutch device has wear, which is instrumental in the axial direction beyond a certain degree, the first body 34 during the return movement from the second axial position to the first axial position can no longer reach its original axial position per FIG. 2A. Instead, the first body 34 or the entire wear compensation mechanism 18 upon reaching the new first axial position by the actuating element 2 in relation to FIG. 2A will be a bit to the left, as indicated by the arrow 15 in FIG. 3A. This actual position of the first body 34 is symbolized in FIG. 3A by the arrow 15. Accordingly, upon reaching the new, wear-related, first axial position by the actuating element 2, the angle α between the centrifugal masses 20 and the shaft 14 per FIG. 3B is also reduced in relation to the originally larger angle α per FIG. 2B.

The wear-related actual position 15 of the first body 34 of the wear compensation mechanism 18, once again detected by the sensor device 40, at the end of the return movement from the second axial position to the first axial position of the actuating element 2, which corresponds here to the engaged position of the friction clutch device and which is illustrated by the arrow 15 in FIG. 3A, is sent as the corresponding actual position signal to the electronic control unit 10. There, the wear-related actual axial position 15 of the first body 34, corresponding to the now also new wear-related first actual axial position of the actuating element 2, is compared with an axial nominal position stored there for the first body 34, illustrated in FIG. 3A by the broken line 17. Upon a deviation of the new actual axial position 15 of the first body 34 of the wear compensation mechanism 18 from the axial nominal position 17 as detected by the control unit 10 and exceeding a permissible dimension, the electronic control unit 10 then controls the electric motor 12 such that the shaft 14 is driven in a second rotation direction 9 opposite the first rotation direction, in which the freewheel 36 couples the first body 34 in rotation with the shaft 14 and the first body 34 is rotated relative to the second body 38, changing the axial length of the wear compensation mechanism 18, such that the actual/nominal deviation is equalized. The actual/nominal deviation to be adjusted by the electric motor 12 with the aid of the wear compensation mechanism 18 is illustrated in FIG. 3A by the axial distance between the actual position 15 and the nominal position 17.

FIG. 4A then shows the state after the adjustment for wear, in which the axial distance between the actual position 15 and the nominal position 17 is again equal to zero. Neither is the length change ΔL, caused by the rotation of the first body 34, of the wear compensation mechanism 18 between the two arrows shown true to scale here. As emerges from FIG. 4B, after the adjustment the centrifugal masses 20 then take up once more the original angle α in relation to the shaft 14, as was originally present, i.e., before the occurrence of the wear per FIG. 2B. Because the friction clutch device is not yet worn down, the actual position 15 agrees with the nominal position of the first body 34 in FIG. 2A.

Instead of the change in the actual axial position of the first body 34 of the wear compensation mechanism 18 as a measure of the adjustment for wear, it is also possible, as mentioned above, to alternatively use for this the actual axial position of the second body 38, of the actuating element 2 itself, or of the pressure piece 24 and to compare this with a corresponding predetermined axial nominal position and compensate for the deviation.

Instead of the activation of a friction clutch device, the above described actuator may be used for any systems transmitting force by frictional locking, especially also for the activation of a wheel friction braking device. In this case, the first axial position of the actuating element of the actuator corresponds to a release position of the wheel friction braking device, in which the wheel friction braking device is released, while the second axial position of the actuating element represents an applied position, in which the wheel friction braking device is applied.

### THE LIST OF REFERENCE NUMBERS IS AS FOLLOWS

1 Actuator
2 Actuating element
3 Activating element
4 Seat
5 Restoring force
6 Longitudinal axis
7 First rotation direction
8 Housing
9 Second rotation direction
10 Control unit
11 Arrow
12 Rotary drive
13 Arrow
14 Shaft
15 Actual position
16 Transforming mechanism
17 Nominal position
18 Wear compensation mechanism
20 Centrifugal masses
22 Transmission
24 Pressure piece
26 First lever
28 Second lever
30 Compression spring device
32 Extension
34 First body
36 Freewheel
38 Second body
40 Sensor device

1-16. (canceled)

17. An electromechanical actuator for activating, by an actuating element, a system that transmits force by frictional locking, which actuating element at least partially produces or removes a normal force for the frictional locking, comprising:
a) a housing;
b) the actuating element, which is mounted in the housing for axial movement and is movable at least between a first axial position and a second axial position;
c) an electronic control unit;
d) an electromechanical rotary drive, which is controlled by the electronic control unit and which rotationally drives a shaft mounted in the housing;
e) a wear compensation mechanism to compensate for wear of the force transmitting system, which is mounted axially movably in the housing;
f) a transforming mechanism to transform the rotation of the shaft into an axial translation of the wear compensation mechanism, wherein the axial translation of the wear compensation mechanism acts on the actuating element;
wherein the wear compensation mechanism contains at least two mutually rotatable bodies, including a first body and a second body, wherein a relative rotation of the bodies brings about an axial length change of the wear compensation mechanism,
wherein the first body is coupled in rotation with the shaft or decoupled in rotation from the shaft by a freewheel and the second body is led in the housing in an axially movable and torque-proof manner,
wherein the second body actuates the actuating element axially,
wherein the freewheel is configured so that a rotational coupling or rotational decoupling of the shaft in relation to the first body is dependent at least on the rotation direction of the shaft,
wherein a sensor device detects the actual axial position of at least one body of the actuator moved in translation by rotation of the shaft in the first axial position of the actuating element and sends a corresponding actual position signal to the electronic control unit,
wherein in the electronic control unit an axial nominal position is stored for the at least one body of the actuator moved in translation by rotation of the shaft in the first axial position of the actuating element,
wherein the electronic control unit controls the rotary drive for moving the actuating element from the first axial position to the second axial position such that the shaft turns in a first rotation direction and with a first rotational speed at which the freewheel decouples the first body in rotation from the shaft and the transforming mechanism transforms the rotation of the shaft into an axial translation of the wear compensation mechanism, corresponding to the movement of the actuating element from the first axial position to the second axial position,
wherein the electronic control unit controls the rotary drive for moving the actuating element from the second axial position to the first axial position such that the shaft turns in the first rotation direction and with a second rotational speed, less than the first rotational speed, at which the freewheel decouples the first body in rotation from the shaft, and
wherein upon the control unit detecting a deviation beyond a permitted degree of the actual axial position of the at least one body of the actuator having moved in translation by the rotation of the shaft from the axial nominal position, the electronic control unit controls the rotary drive such that the shaft is actuated in a second rotation direction, opposite to the first rotation direction, in which the freewheel couples the first body to the shaft in rotation and the first body is turned relative to the second body, changing the axial length of the wear compensation mechanism, such that the deviation is compensated.

18. The actuator of claim 17, wherein the transforming mechanism is configured so that it transforms the rotation of the shaft into an axial translation of the wear compensation mechanism depending on the rotational speed of the shaft.

19. The actuator of claim 18, wherein the transforming mechanism is centrifugally controlled, wherein an increasing rotational speed of the shaft produces larger centrifugal forces and a greater translation and a decreasing rotational speed of the shaft produces smaller centrifugal forces and a lesser translation.

20. The actuator of claim 19, wherein the centrifugally controlled transforming mechanism contains at least the following:
a1) at least one centrifugal mass which is rotary driven by the shaft, extendable or retractable in the radial direction, whose radial extending movement or retracting movement is dependent on the rotational speed of the shaft, wherein the extending movement becomes greater with increasing rotational speed and lesser with decreasing rotational speed; and
b1) a transmission which is rotationally coupled to the shaft, transforming the radial extending movement or retracting movement of the at least one centrifugal mass into an axial movement of a pressure piece co-rotating with the shaft, and axially movable with respect to the shaft.

21. The actuator of claim 20, wherein the pressure piece is rotationally coupled via the freewheel to the first body of the wear compensation mechanism or rotationally decoupled from the first body of the wear compensation mechanism, depending on its rotation direction.

22. The actuator of claim 20, wherein the pressure piece is axially braced against the shaft by a compression spring device.

23. The actuator of claim 20, wherein the transmission which is rotationally coupled to the at least one centrifugal mass is a lever transmission.

24. The actuator of claim 23, wherein the lever transmission includes at least one first lever, which is mounted to co-rotate with the shaft and is pivotable on the shaft, directly or indirectly, about an axis which is perpendicular in relation to the axial direction and which carries at one end at least one centrifugal mass and axially activates the pressure piece directly or indirectly by its other end.

25. The actuator of claim 17, wherein the first body of the wear compensation mechanism is configured to be screwed by a thread with respect to the second body of the wear compensation mechanism.

26. The actuator of claim 17, wherein the actuating element is formed by the second body.

27. The actuator of claim 17, wherein the rotary drive is formed by an electric motor.

28. The actuator of claim 17, wherein the body of the actuator which is moved in translation by rotation of the shaft is formed by a body of the wear compensation mechanism, the actuating element or the pressure piece.

29. A system transmitting apparatus for transmitting a force by frictional locking, comprising:
a system transmitting device, in which frictional forces between two frictional partners are generated in dependence on a normal force, wherein the normal force is at least partly produced or removed by an actuator;
wherein the actuator includes:
a) a housing;
b) the actuating element, which is mounted in the housing for axial movement and is movable at least between a first axial position and a second axial position;
c) an electronic control unit;
d) an electromechanical rotary drive, which is controlled by the electronic control unit and which rotationally drives a shaft mounted in the housing;
e) a wear compensation mechanism to compensate for wear of the force transmitting system, which is mounted axially movably in the housing;
f) a transforming mechanism to transform the rotation of the shaft into an axial translation of the wear compensation mechanism, wherein the axial translation of the wear compensation mechanism acts on the actuating element;
wherein the wear compensation mechanism contains at least two mutually rotatable bodies, including a first body and a second body, wherein a relative rotation of the bodies brings about an axial length change of the wear compensation mechanism,
wherein the first body is coupled in rotation with the shaft or decoupled in rotation from the shaft by a freewheel and the second body is led in the housing in an axially movable and torque-proof manner,
wherein the second body actuates the actuating element axially,
wherein the freewheel is configured so that a rotational coupling or rotational decoupling of the shaft in relation to the first body is dependent at least on the rotation direction of the shaft,
wherein a sensor device detects the actual axial position of at least one body of the actuator moved in translation by rotation of the shaft in the first axial position of the actuating element and sends a corresponding actual position signal to the electronic control unit,
wherein in the electronic control unit an axial nominal position is stored for the at least one body of the actuator moved in translation by rotation of the shaft in the first axial position of the actuating element,
wherein the electronic control unit controls the rotary drive for moving the actuating element from the first axial position to the second axial position such that the shaft turns in a first rotation direction and with a first rotational speed at which the freewheel decouples the first body in rotation from the shaft and the transforming mechanism transforms the rotation of the shaft into an axial translation of the wear compensation mechanism, corresponding to the movement of the actuating element from the first axial position to the second axial position,
wherein the electronic control unit controls the rotary drive for moving the actuating element from the second axial position to the first axial position such that the shaft turns in the first rotation direction and with a second rotational speed, less than the first rotational speed, at which the freewheel decouples the first body in rotation from the shaft, and
wherein upon the control unit detecting a deviation beyond a permitted degree of the actual axial position of the at least one body of the actuator having moved in translation by the rotation of the shaft from the axial nominal position, the electronic control unit controls the rotary drive such that the shaft is actuated in a second rotation direction, opposite to the first rotation direction, in which the freewheel couples the first body to the shaft in rotation and the first body is turned relative to the second body, changing the axial length of the wear compensation mechanism, such that the deviation is compensated.

30. The system transmitting apparatus of claim 29, wherein it is formed by a friction clutch device of a drive machine of a vehicle or a wheel friction braking device of a vehicle.

31. The system transmitting apparatus of claim 30, wherein the first axial position for the friction clutch device represents an engaged state and the second axial position a disengaged state.

32. The system transmitting apparatus of claim 30, wherein the first axial position for the wheel friction braking device represents a released state and the second axial position an applied state.
